(19) United States
(12) Patent Application Publication
(10) Pub. No.: US 2008/0289088 A1
(43) Pub. Date: Nov. 27, 2008

(54) N-ALKYLCHITOSAN FILMS AND LAMINATES MADE THEREFROM

(75) Inventor: Edward George Howard, JR., Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. du Pont de Nemours and Company, Wilmington, DE (US)

(21) Appl. No.: 12/177,196

(22) Filed: Jul. 22, 2008

Related U.S. Application Data
(63) Continuation-in-part of application No. 11/593,958, filed on Nov. 7, 2006.
(60) Provisional application No. 60/734,326, filed on Nov. 7, 2005.

(51) Int. Cl. A62B 17/00; D03D 25/00; B32B 27/12

(52) U.S. Cl. 2/457; 442/181; 442/394

(57) ABSTRACT

N-alkylchitosan films, composite films, and, laminates, made from the films are provided. The films and laminates can be used to make a variety of finished articles that can be used to provide protection from hazardous chemical and biological agents.

This application is a continuation-in-part of U.S. patent application Ser. No. 11/593,958, filed Nov. 7, 2006, which in turn claims the benefit of priority of U.S. Provisional Application No. 60/734326, filed Nov. 7, 2005.

### TECHNICAL FIELD

The present invention relates to laminates prepared in part from continuous N-alkylchitosan films. In various embodiments, the laminates are useful for fabrication as a protective article and are preferably substantially impermeable to hazardous chemical and biological agents, but sufficiently permeable to water vapor that, if worn as protective apparel, it is both protective and comfortable to wear.

### BACKGROUND

There is a growing need for structures that provide personal protection against toxic chemical and biological agents. It is known to devise structures that are impermeable to toxic chemical vapors and liquids, but, when used as apparel, such structures are typically also hot, heavy and uncomfortable to wear.

The degree of comfort offered by apparel worn as a protective suit is significantly affected by the amount of water vapor that can permeate through the fabric from which the suit is made. The human body continuously perspires water to be evaporated as a method for controlling body temperature. When a protective fabric hinders the loss of water vapor from the body, the transpirational evaporative cooling process is hindered, which leads to personal discomfort. When a protective suit allows little or no loss of water vapor, extreme heat stress or heat stroke can result in a short period of time. Hence, it is desirable that, in addition to offering the highest levels of protection against toxic chemicals and liquids, a practical chemical and biological protective suit should have high water vapor transmission rates. It is also desirable that the appropriate protective structure be light in weight and offer the same high level of protection over a long period of time. N-alkylchitosans with up to six carbons and different degrees of substitution of the N-alkyl group were prepared by T. Uragami et al. in a study of N-alkylchitosan membranes for pervaporation of aqueous ethanol solutions (Journal of Membrane Science 124 (1997) 203-211).

The present invention provides selectively permeable laminates that contain a continuous N-alkylchitosan film and that can be used in articles for personal protection, providing improved wearer comfort compared with impermeable articles.

### SUMMARY OF THE INVENTION

One aspect of the present invention is a method of inhibiting the permeation of a chemically or biologically harmful agent through a laminate or a structure or item of apparel fabricated therefrom, by including within the laminate a continuous N-alkylchitosan film

Another aspect of the present invention is a protective structure comprising a continuous N-alkylchitosan film. In some embodiments, the structure is a laminate further comprising at least one layer of fabric.

A further aspect of the present invention is a finished article incorporating a laminate that comprises a continuous N-alkylchitosan film and at least one layer of fabric. Finished articles include items of apparel, shelters, and protective covers.

These and other aspects of the present invention will be apparent to one skilled in the art in view of the following description and the appended claims.

### BRIEF DESCRIPTION OF THE DRAWINGS

FIG. 1 is a schematic diagram showing the structure of one type of selectively permeable laminate according to an embodiment of the present invention.

### DETAILED DESCRIPTION

In the context of this disclosure, a number of terms shall be utilized. The term “film” as used herein means a thin but discrete structure that moderates the transport of species in contact with it, such as gas, vapor, aerosol, liquid and/or particulates. A film may be chemically or physically homogeneous or heterogeneous. Films, as used herein, are less than about 0.25 mm thick.

The term “sheet” as used herein means a film that is at least 0.25 mm thick.

Unless otherwise stated or apparent by the particular context, the term “N-alkylchitosan” as used herein includes N-alkylated chitosan-based moieties, including the N-alkylchitosans themselves, and their salts and derivatives. The alkyl group may be 1 to 12 carbons in length.

The term “N-alkylchitosan film” as used herein means a film that contains at least one N-alkylchitosan-based moiety in the amount of at least 50% by weight.

The term “nonporous” as used herein denotes a material or surface that does not allow the passage of air other than by diffusion.

The term “continuous N-alkylchitosan film” as used herein means an N-alkylchitosan film having at least one nonporous surface.

The term “permeable” as used herein means allowing liquids or gases to pass or diffuse through.

The term “selectively permeable” as used herein means allowing passage of certain species but acting as a barrier to others. The protective structures disclosed herein are selectively permeable in that they are permeable to water vapor but have minimal or no permeability (thus, act as a barrier) to chemical agents. The term “laminate” as used herein means a material comprising two or more parallel layers of material that are at least partially bonded to each other.

The term “substrate” as used herein means the material onto which a film is formed from solution.

The term “work device” as used herein denotes a substrate which is used only for film formation and does not subsequently become part of a laminate.

The term “soluble” as used herein denotes a material that forms a visibly transparent solution when mixed with a specified solvent. For example, a water-soluble material forms a transparent solution when mixed with water, while a water-insoluble material does not.

The term “N-alkylchitosan solution” as used herein indicates that at least one N-alkylchitosan moiety is dissolved in the indicated solvent. However, materials that are insoluble in the indicated solvent may also be present.

The term “(in)solubilize” as used herein means to render a material (in)soluble in a specified solvent.

The term “toxin” as used herein means a poisonous substance, typically a protein or mixture of proteins, produced by a living organism (e.g., plants, animals, or pathogenic bacteria. A toxin typically has a high molecular weight (as compared to a simple chemical poison), is antigenic (elicits an antibody response), and is highly poisonous to living creatures.

The term “harmful to human health” as used herein means causing injury to humans as a consequence of acute or chronic exposure through dermal contact, ingestion, or respiration.

In preferred embodiments, the N-alkylchitosan films and laminates made therefrom are substantially impermeable to certain biological and/or chemical agents. It is often desirable that the films and laminates be at least 99% impermeable to certain agents, even up to 100% impermeable.

In one embodiment, the present invention provides a protective structure, fabricated from a continuous N-alkylchitosan film or a selectively permeable laminate containing a continuous N-alkylchitosan film. “Structure”, as used herein with regard to structures fabricated from the continuous N-alkylchitosan film, includes single layers and multiple layers of continuous N-alkylchitosan films. These films can be used to make laminates. The structures can be used in articles and items of apparel that protect against exposure to a chemical or biological agent that is harmful to human health. Specific embodiments include finished articles, including articles of apparel, fabricated from a continuous N-alkylchitosan film or a selectively permeable laminate containing a continuous N-alkylchitosan film.

In other embodiments, the invention provides methods of inhibiting the permeation of a chemically or biologically harmful agent through a selectively permeable laminate, or through an article or item of apparel fabricated therefrom, by including within the selectively permeable laminate a continuous N-alkylchitosan film.

In further embodiments the invention provides methods of fabricating a structure that protects against exposure to a chemical or biological agent that is harmful to human health, and methods of fabricating items of apparel, by incorporating into a structure or item of apparel a selectively permeable laminate containing an N-alkylchitosan film.

Because the laminates are selectively permeable, we have found that a structure fabricated therefrom provides a protective barrier that inhibits the permeation through the laminate, and thus through the structure, of chemical and biological agents that may be harmful to humans while maintaining sufficient water vapor permeability to maintain personal comfort when the laminate is used to fabricate an item of apparel.

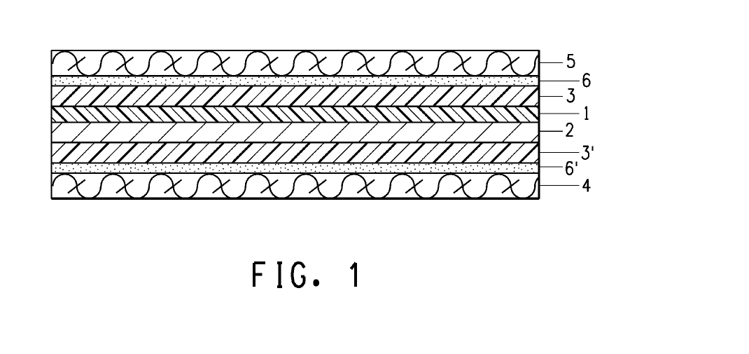

The selectively permeable laminates described herein contain a continuous N-alkylchitosan film. In one embodiment, the laminate is an N-alkylchitosan film deposited from solution onto a substrate. In another embodiment, the laminate is an N-alkylchitosan film adhered to a layer, for example, polyurethane film by thermal bonding. In another embodiment, a continuous N-alkylchitosan film or an N-alkylchitosan film cast onto a substrate, or an N-alkylchitosan film thermally bonded to another layer is bonded to one or more layers of fabric, by adhesive. The adhesive can be in the form of stripes or, preferably, dots, to provide a discontinuous layer of adhesive, in order not to block passage of gases and/or liquids through the selectively permeable laminate. FIG. 1 illustrates one embodiment of a selectively permeable laminate that could be used in, for example, an article of apparel. In the embodiment shown, the laminate contains the following elements a continuous N-alkylchitosan film (1); a substrate to which the continuous N-alkylchitosan film is adhered (2); additional layers (3, 3′); an inner liner (4); an outer shell (5) and adhesive (6,6′). However, not all embodiments of the selectively permeable laminates contain all of the elements shown in FIG. 1.

### Continuous N-alkylchitosan Film

Chitosan is the commonly used name for poly-[1-4]-β-D-glucosamine. It is commercially available and is chemically derived from chitin, which is a poly-[1-4]-β-N-acetyl-D-glucosamine that, in turn, is derived from the cell walls of fungi, the shells of insects and, especially, crustaceans. In the preparation from chitin, acetyl groups are removed by treatment with strong base, and, in the chitosan used herein, the degree of deacetylation is at least about 60%, and is preferably at least about 85%. As the degree of deacetylation increases, it becomes easier to dissolve chitosan itself in acidic media.

N-alkylated chitosans have been prepared with alkyl groups from 1 to 12 carbons long and with varying degrees of N-substitution (Uragami, op cit; R. A. A. Muzzarelli et al., Journal of Membrane Science 16 (1983) 295-308; D. de Britto and O. B. G. de Assis, International Journal of Biological Macromolecules 41 (2007) 198-203). One synthetic method is to react the chitosan with the alkyl aldehyde and reduce the product obtained with, for example, sodium borohydride. N,N-dimethylchitosan can be prepared by reacting chitosan with formaldehyde in the presence of formic acid (see, e.g., U.S. Pat. No. 4,826,826). Quaternized forms, e.g., N,N,N-trimethyl- and N,N,N,-triethylchitosan salts have also been prepared by, for example, R. A. A. Muzzarelli and F. Tanfani (Carbohydrate Polymers 5(4) (1985)297-307), A. B. Sieval et al. (Carbohydrate Polymers 36 (1998) 157-165) and L. A. Nud'ga et al. (Zhurnal Obshchei Khimii 43(12) (1973) 2756-60).

Chitosan can also be converted to N-methylchitosan by the reaction of chitosan with a methylating agent, such as dimethyl sulfate, methyl iodide, trimethylphosphate and the like, usually carried out in the presence of a base. Examples of readily available bases include alkaline or alkaline earth hydroxides or carbonates. This chemical transformation can be carried out on chitosan powder to yield N-methylchitosan powder, which is then washed and dried. The N-methylchitosan powder is then converted to film by dissolving it in a solvent to form a solution, casting the solution, drying, and, optionally, treating the film with base and/or heating to convert the N-methylchitosan film to an insoluble form. Alternatively, a preformed chitosan film can be directly converted to N-methylchitosan by applying the methylating conditions described above.

N-alkylchitosan-based moieties that are suitable for use in the embodiments described herein include N-alkylchitosan itself, N-alkylchitosan salts, and N-alkylchitosan derivatives. Representative examples of chitosan derivatives suitable for use in this invention include O-carboxymethylated N-alkylated chitosans (N. Song et al., Zhongguo Haiyang Yaowu 20(1) (2001) 32-33, 41). The number average molecular weight (Mₙ) in aqueous solution of the N-alkylchitosan used herein is at least about 10,000.

An N-alkylchitosan film may be cast from solution. If it is desired to cast an N-alkylchitosan film from an aqueous solution, however, the N-alkylchitosan is first solubilized, since N-alkylchitosan itself is not soluble in water. Preferably, solubility is obtained by adding the N-alkylchitosan to a dilute solution of a water-soluble acid. This allows the N-alkylchitosan to react with the acid to form a water-soluble salt, herein referred to as an “N-alkylchitosan salt” or “N-alkylchitosan as the (acid anion) thereof”, for example “N-alkylchitosan as the acetate thereof” if acetic acid was used. N-alkylchitosan derivatives such as O-carboxyalkyl N-alkylchitosans that are water-soluble can be used directly in water without the addition of acid.

The acid used to solubilize the N-alkylchitosan may be inorganic or organic. Examples of suitable inorganic acids include without limitation hydrochloric acid, sulfamic acid, hot sulfuric acid, phosphoric acid and nitric acid. Suitable organic acids may be selected from the group consisting of water-soluble mono-, di- and polycarboxylic acids. Examples include without limitation formic acid, acetic acid, pimellic acid, adipic acid, o-phthalic acid, and halogenated organic acids. Other suitable acids are disclosed in U.S. Pat. No. 2,040,880. Mixtures of acids may also be used. Volatile acids, that is, those with a boiling point less than about 200° C., are preferred.

The amount of acid used to solubilize the N-alkylchitosan can be chosen to control the viscosity. If too little acid is added, the resulting solution may be too viscous to cast a thin film and/or to be filtered. The desired amount of acid used will also depend on the desired N-alkylchitosan concentration in the solution from which the film is cast. It will depend as well on the molecular weight and degree of deacetylation of the chitosan that was alkylated, since those properties determine the molar concentration of alkylamino groups available to react with the acid. Preferably, about one acid equivalent is added per equivalent of the amine nitrogens in the N-alkylchitosan.

The appropriate concentration of N-alkylchitosan in the solution will vary depending on how the solution is to be applied, and also on the molecular weight of the N-alkylchitosan, as a lower concentration may be desired for a relatively high molecular weight N-alkylchitosan. Different application methods work best with solutions of different viscosities, but typically, the solution will contain from about 0.1 to about 15 wt % N- alkylchitosan, based on the total combined weight of the solution and the N-alkylchitosan.

The N-alkylchitosan solution from which the film is prepared may include organic polymers, including without limitation, natural polymers such as starch or cellulose or even the unalkylated chitosan itself, and synthetic polymers such as polyurethanes, polyamides, and polyesters. Such polymers may be soluble or insoluble in the N-alkylchitosan solution. For example, a polyamide may be dissolved in a solution of N-alkylchitosan and formic acid, while a polyurethane suspension in water would remain a suspension when added to an N-alkylchitosan/acetic acid solution. In some embodiments, the presence of another polymer in solution with an N-alkylchitosan allows the formation of films with improved characteristics. In one embodiment, a “composite film” of chitosan and N-methylchitosan, i.e., a film cast from a solution of chitosan and N-methylchitosan, is much more flexible than either chitosan film or N-methylchitosan film.

The N-alkylchitosan solution from which the film is prepared may include inorganic fillers, including without limitation, glass spheres, glass bubbles, clays (e.g., sepiolite, attapulgite, and montmorillonite), silica, alumina, titania, and the like. Small amounts of such fillers, preferably less than 10 wt %, can be used to increase thermal stability, modulus, and barrier properties of the N-alkylchitosan film where this is desirable.

The N-alkylchitosan solution from which the film is prepared may include additives such as flame retardants, plasticizers, stabilizers, tougheners, and the like, to enhance various properties of the N-alkylchitosan film such as strength, flexibility, fire resistance and dimensional stability. For example, flexibility of the film when wet can be enhanced by addition of ketoacids such as glyoxylic acid and levulinic acid. In other examples, film insolubility can be obtained by adding sugars such as glucose and fructose to the N-alkylchitosan solution. Additives to an N-alkylchitosan solution may be soluble in the solution, or they may be present as dispersed insoluble material. Adding sugars, di- or multi-functional acids, or polyhydroxyl compounds can reduce the thermal requirements for rendering the N-alkylchitosan insoluble. With these additives, annealing temperatures of about 100° C.-120° C. for about 1 to 10 minutes cause insolubility. The additives are present at less than 50% by weight, based on the total combined weight of N-alkylchitosan and additives.

An N-alkylchitosan film may be prepared by casting an N-alkylchitosan solution directly onto a substrate that will be incorporated along with the film into a laminate. Alternatively, the N-alkylchitosan solution may be cast onto a work device such as a smooth surface, such as glass or a polymer film (for example, polyester film). If the film is cast onto a work device, the film is then dried, detached and then incorporated into a laminate in a separate step.

The solution may be applied to a substrate by any of a variety of methods known in the art. For a small scale process, such as a laboratory test sample, the solution is typically applied using a doctor knife. Methods available to coat surfaces which are planar and have irregular surfaces include without limitation spray coating, dip coating, and spin coating. In a commercial process, the solution could be applied to, e.g., traveling web using methods that include without limitation reverse roll, wire-wound or Mayer rod, direct and offset gravure, slot die, blade, hot melt, curtain, knife over roll, extrusion, air knife, spray, rotary screen, multilayer slide, coextrusion, meniscus, comma and microgravure coating. These and other suitable methods are described by Cohen and Gutoff in “Coating Processes” in the Kirk-Othmer Encyclopedia of Chemical Technology [John Wiley & Sons, 5^{th} edition (2004), Volume 7, Pages 1-35]. The method chosen will depend on several factors, such as the rheology of the solution to be applied, the desired wet film thickness, the speed of a substrate that is traveling, and the required coating accuracy as a percent of total thickness.

The applied solution is then dried by any suitable method known in the art such as exposure to a hot air oven, air impingement drying, or radiative (e.g. infrared or microwave) drying (See, generally, Cohen and Gutoff, op. cit.). The result of the drying at this stage is a continuous film. If the N-alkylchitosan is dissolved in an aqueous solution of a volatile acid, that is, an acid whose boiling point is less than about 200° C., exposure to ambient air may be sufficient for drying, and drying will remove acid as well as water.

If a film at this stage is water-soluble, it can be made water-insoluble by heating; by reacting it with a crosslinking reagent; by treatment with a strong base; or by a combination of two or more of these methods. For example, a film cast from a formic acid solution can be made water-insoluble by heat treatment after the film has been formed and dried, for example, by heating at about 1000 to about 260° C. for about 0.1 to about 60 minutes, or more preferably about 100° C. to 180° C. for about 1 to 10 minutes. Heat treatment plus the use of a crosslinking agent could also be used to render the N-alkylchitosan film insoluble.

The film can also be made insoluble by adding any of a variety of crosslinking agents to a solution before a film is cast therefrom. A crosslinking agent is a reactive additive that creates bonds, i.e. crosslinks, between polymer chains. Examples of crosslinking agents for N-alkylchitosan include without limitation glutaraldehyde (X. Peng et al., Carbohydrate Polymers 65 (2006) 288-295), epichlorohydrin, and di-, and tri-carboxylic acids including succinic, malic, tartaric, and citric acids. Diacids such as adipic acid or other multifunctional acids such as levulinic acid, glyoxylic acid or halogenated organic acids, can be used to make the N-alkylchitosan solution. With these additives, temperatures of about 100° C. −120° C. for about 1 to 10 minutes can cause insolubility. Crosslinking agents may also be applied to the film after it is dried.

The film can also be made water-insoluble by contacting the film with a base and then washing, which converts the film from the N-alkylchitosan salt form to N-alkylchitosan. If the film to be treated with base is attached to a substrate, the composition and concentration of the base will be influenced by the nature of the substrate (e.g., its reactivity toward base) and processing conditions (e.g., temperature and contact time, continuous versus batch process). Typically, the base is a 1% to 10% by weight aqueous solution of sodium hydroxide, and typical contact times are 30 seconds to 3 hours at ambient temperature. Heat treatment plus contact with base could also be used to render the film insoluble.

### Substrate Materials

Although a free-standing N-alkylchitosan film can be incorporated into a protective article, it can also be adhered to a substrate. Referring to FIG. 1, an N-alkylchitosan film 1 may be prepared by casting an N-alkylchitosan solution directly onto a substrate 2 that will be incorporated along with the film into a laminate. It can also be cast on a work surface like PET film and coated with an additional layer or layers before or after the work surface is removed and discarded. In certain cases, the substrate onto which an N-alkylchitosan film may be prepared may itself be a continuous sheet or film, provided that the permeability of the substrate to water vapor under use conditions is adequate for the particular end use. For example, a garment would require much higher water vapor permeability than a tent or tarpaulin.

A suitable substrate will have at least one surface that is smooth, i.e., essentially without protrusions above the plane of the substrate that are higher than the desired thickness of the coating of N-alkylchitosan that will be transformed into the film. Thus, a smoother substrate surface is required when the desired thickness of the coating of N-alkylchitosan is 25 microns than when it is 100 microns.

A suitable substrate may be, for example, a film, a sheet whose permeability to water vapor under use conditions is adequate for the particular end use, a microporous membrane (i.e., one in which the typical pore size is about 0.1 to 10 micrometers in diameter), or an article prepared from any of the foregoing. It is preferred that the substrate surface that will be in contact with the N-alkylchitosan film be both smooth and nonporous. Suitable substrate materials include polar polymer films, including elastomers, glassy polymers, and semi-crystalline materials. A polar polymer has both dispersion and dipole-dipole forces, while a non-polar polymer has only dispersive attractive forces. Polar polymers generally contain a substantial fraction of oxygen and nitrogen containing groups, while non-polar polymers contain a substantial fraction of hydrocarbon or fluorocarbon with minimal oxygen and nitrogen containing groups. However, the N-alkylchitosan solution will wet non-polar surfaces if a surface active agent is added to the N-alkylchitosan solution. Examples of such surface active agents are N-dodecylpyridinium salts or ethylene oxide/propylene oxide block copolymers. The surfaces of non-polar films can be made polar by treatment with corona discharge in air.

Examples of suitable substrate materials include without limitation Nafion® perfluorosulfonic acid tetrafluoroethylene copolymer(available from E. I. du Pont de Nemours and Company, Wilmington, Del., USA), polyurethanes (e.g., polyurethane films available from Omniflex Co., Greenfield , Mass., USA), polyether block polyamide copolymers (e.g., Pebax® polyether block amides available from Arkema, Paris, France), polyether block polyester copolymers, sulfonated styrene-polyolefin di- and tri-block copolymers, and polyvinyl alcohol homopolymers and copolymers.

### Additional Layers

The protective laminates described herein comprise a continuous N-alkylchitosan film and at least one layer of fabric. As appropriate, additional layers (for example, a second fabric layer or a microporous membrane) can be used in a laminate with the objective of (a) creating a composite structure that protects the N-alkylchitosan film from an environment that may degrade its performance, and/or (b) creating a laminate, and potentially thus a composite structure thereof, that has features in addition to those offered only by the N-alkylchitosan film and the at least one fabric layer, and/or (c) improving the performance of the final structure. For example, additional films or microporous membranes may be applied to the outer surfaces of the N-alkylchitosan film and, where present, the substrate, as shown in FIG. 1 (3, 3′) by coating, thermal lamination, and other means known in the art, to protect the N-alkylchitosan and substrate films from dust and liquids or physical damage. One or more layers of ballistic fabrics can be used to absorb the impact of a projectile and protect the wearer from harm.

In many end uses, particularly apparel, the continuous N-alkylchitosan film (and its associated substrate, where present) is incorporated into a structure that includes an outer layer of material (an “outer shell,” 5 in FIG. 1) which is exposed to the environment and/or an inner liner 4.

The outer and inner materials may each be chosen for functional reasons such as ruggedness, ballistic resistance, and resistance to abrasion or tearing, as well as to impart a comfortable feel and a fashionable appearance to apparel. Colored and patterned materials may also be used as outer layers to introduce camouflage features in military applications. The outer shell and inner liner materials are typically fabric or microporous membranes.

Fabrics may be wovens or nonwovens (e.g., nonwoven sheet structures created by spun bonded/melt blown processes or by electrospinning as described in, e.g., Z.-M. Huang et al., Composites Science and Technology (2003), 63, 2223-2253). Fabrics may be prepared from any synthetic or natural fiber appropriate for the specific end use in mind. Preferred fabrics may be prepared from aramids, nylons, polyesters, cotton, and blends comprising any of these, such as, but not limited to blends of nylon and cotton fibers (“NYCO”). The term “nylon” as used herein refers to polyamides other than aramids. An aramid is an aromatic polyamide, wherein at least 85% of the amide (—CONH—) linkages are attached directly to two aromatic rings. Flame retardant fibers, including other aramids (preferably up to 40%), may be blended with an aramid to impact fabric thermal performance and comfort. A suitable aramid may be in the form of a copolymer that may have as much as 10 percent of other diamine(s) substituted for the diamine of the aramid or as much as 10 percent of other diacid chloride(s) substituted for the diacid chloride of the aramid. In some embodiments, the fabric is a p-aramid. In some embodiments, the p-aramid is poly (p-phenylene terephthalamide) (PPD-T). M-aramids may also find use in the present invention, and in some embodiments the m-aramid is poly (m-phenylene isophthalamide) (MPD-I). P-aramid and m-aramid fibers and yarns particularly suitable for use in the present invention are those sold respectively under the trademarks Kevlar® and Nomex® (E. I. du Pont de Nemours and Company, Wilmington Del., USA), and Teijinconex®, Twaron® and Technora® (Teijin Ltd., Osaka, Japan), and equivalent products offered by others. Typically, the aramid fabric would be used in the outer shell, and the inner liner would more likely contain fabric such as polyester, nylon, cotton, or blends thereof, though m-aramids may be utilized as part of the inner liner as well to improve fire resistance Films and microporous membranes may be prepared from any synthetic or natural material appropriate for the specific end use in mind. Examples of films and microporous membranes that can be used as a component of inner liners or outer shells include without limitation expanded poly(tetrafluoroethylene) membranes such as those sold under the trademark GORE-TEX® (W. L. Gore & Associates, Inc., Newark, Del., USA); hydrophobic polyurethane microporous membranes (see, e.g., S. Brzezinski et al., Fibres & Textiles in Eastern Europe, January/December 2005, 13(6), 53-58); microporous (poly)propylene available from ,e.g., 3M (St. Paul, Minn., USA); thin films of thermoplastic polyurethane such as those sold under the trademark Transport® Brand Film by Omniflex (Greenfield, Mass., USA); Pebax® polyether block amide by Arkema (Paris, France); and DuPont™ Active Layer, a polyester film available from E. I. du Pont de Nemours and Company (Wilmington, Del., USA).

### Laminate Fabrication

The selectively permeable laminates described herein can be assembled using any of the any of the sewing, stitching, stapling or adhering operations, such as thermally pressing, known in the art.

Referring to FIG. 1, the layers to be assembled include the N-alkylchitosan film 1 and at least one other layer. For example, if the N-alkylchitosan film is cast on a work device, the film is then dried and detached as a free-standing film. Other layers could be added either before or after detachment from the work device. It may then be attached to another layer (for example, substrate (2), outer shell (5), inner liner (4)) using an adhesive (for example, (6, 6′) in FIG. 1) such as a polyurethane-based adhesive. The adhesive may be present as a continuous layer, an array of adhesive dots, or in a number of alternative patterns such as lines or curves. The adhesive may be applied in a variety of ways including spraying or gravure roll.

To fabricate a structure or other article from a laminate disclosed herein, such as an item of apparel, the laminate may be sandwiched between (additional) woven fabrics. Bonding between the film structure and the fabrics may be continuous or semicontinuous, for example, with adhesive dots or films. Alternatively, the bonding may be discontinuous, for example by sewing the edges together, an arrangement often referred to as a “hung liner”. Other means of discontinuous bonding may include the use of Velcro® strips or zippers.

### Uses

The laminate, as well as the continuous N-alkylchitosan film itself, is selectively permeable, having a Moisture Vapor Transport Rate (“MVTR”) of at least 2 kg m²/24 h, while the transport rate of materials harmful to human health is low enough to prevent the occurrence of injury, illness or death. The specific transport rate needed will necessarily depend on the specific harmful material; for example, NFPA 1994, 2006 Revision requires <4.0 μg/cm² one hour cumulative permeation for mustard and <1.25 μg/cm² for Soman, both of which requirements are met by the laminates and the continuous N-alkylchitosan film it contains. Consequently, the laminates, as well as the continuous N-alkylchitosan film itself, can be used for the fabrication of, or as a component in, a variety of articles of manufacture, including articles of protective apparel, especially for clothing, garments or other items intended to protect the wearer or user against harm or injury as caused by exposure to toxic chemical and/or biological agents, including without limitation those agents potentially used in a warfighter environment and materials identified as “Toxic Industrial Chemicals” (TICs) or “Toxic Industrial Materials” (TIMs); see, for example, Guide for the Selection of Chemical and Biological Decontamination Equipment for Emergency First Responders, NIJ Guide 103-00, Volume I, published by the National Institute of Justice, U.S. Department of Justice (October 2001), herein incorporated by reference. A TIC (or TIM) is an industrial chemical that has an LCt₅₀ value (lethal concentration of a chemical vapor or aerosol for 50% of the population multiplied by exposure time) less than 100000 mg/min·m³ in any mammalian species and is produced in quantities exceeding 30 tons per year at one production facility. A few examples of TICs are phosgene, chlorine, parathion, and acrylonitrile. Permeability of the laminate or a layer in the laminate to specific substances may be determined by various methods including, without limitation, those described in ASTM F739-91, “Standard Test Method for Resistance of Protective Clothing Materials to Permeation by Liquids or Gases Under Conditions of Continuous Contact.”

In one embodiment, the item of apparel is useful to protect military personnel against dermal exposure to chemical and biological agents potentially encountered in a warfighter environment. Examples of such agents include without limitation nerve agents, vesicant agents, tear gases (riot control agents), and human pathogens. Examples of nerves agents include without limitation: Sarin (“GB,” O-isopropyl methylphosphonofluoridate), Soman (“GD,” O-Pinacolyl methylphosphonofluoridate), Tabun (“GA,” O-Ethyl N,N-dimethylphosphoramidocyanidate), and VX (O-Ethyl S-2-diisopropylaminoethyl methylphosphonothiolate). Examples of vesicant agents include without limitation: sulfur mustards (e.g., Bis(2-chloroethyl)sulfide and Bis(2-chloroethylthio)methane), Lewisites (such as 2-chlorovinyldichloroarsine),and nitrogen mustards (such as Bis-(2-chloroethyl) ethylamine (“HN1”)). Examples of tear gases include without limitation: pepper spray (various capsaicinoids), Bromobenzyl cyanide (“CA”), Phenylacyl chloride (“CN”), o-Chlorobenzylidene malononitrile (“CS”), and Dibenzoxazepine (“CR”). Examples of human pathogens include without limitation: viruses (e.g., encephalitis viruses, Ebola virus), bacteria (e.g., Rickettsia rickettsii, Bacillus anthracis, Clostridium botulinum), and toxins (e.g., Ricin, Cholera toxin, Anthrax toxin). A human pathogen is an agent, especially a microorganism that causes disease in humans.

In a further embodiment, the item of apparel is useful to protect first responder personnel from known or unknown chemical or biological agents potentially encountered in an emergency response situation. In yet another embodiment, the item is intended to protect cleanup personnel from chemical or biological agents during a hazmat response situation. Examples of hazardous material in addition to those listed above include certain pesticides, particularly organophosphate pesticides.

Such clothing, garments or other items include without limitation coveralls, protective suits, coats, jackets, limited-use protective garments, raingear, ski pants, gloves, socks, boots, shoe and boot covers, trousers, hoods, hats, masks and shirts.

In another embodiment, the laminates can be used to create a protective cover, such as a tarpaulin, or a collective shelter, such as a tent, to protect against chemical and/or biological warfare agents.

Furthermore, the laminates can be used in various medical applications as protection against toxic chemical and/or biological agents. In one embodiment, the laminates could be used to construct items of apparel for health care workers, such as medical or surgical gowns, gloves, slippers, shoe or boot covers, and head coverings.

### EXAMPLES

Specific embodiments of the present invention are illustrated in the following examples. The embodiments of the invention on which these examples are based are illustrative only, and do not limit the scope of the appended claims.

The meaning of the abbreviations used in the examples is as follows: “cm” means centimeter(s), “cP” means centipoise, “g” means gram(s), “h” means hour(s), “kg” means kilogram(s), “m” means meter(s), “M” means molar, “mg” means milligram(s), “pg” means microgram(s), “min” means minute(s), “mL” means milliliter(s), “μL” means microliter(s), “mm” means millimeter(s), “mmol” means millimole(s), “Mn” means number average molecular weight, “M_{w}” means weight average molecular weight, “oz” means ounce(s), “Pa” means Pascal, “s” means second(s), “SEC” means size exclusion chromatography, wt %” means weight percent, and “yd” means yard(s). Unless otherwise specified, the water used is distilled or deionized water.

The chitosan material used in the following Examples was ChitoClear® TM-656, obtained from Primex Ingredients ASA, Norway under the trademark ChitoClear® chitosan, as noted. According to the manufacturer, Primex ChitoClear® TM-656 has a Brookfield viscosity of 26 cP (0.026 Pa·s, 1% chitosan in a 1% aqueous acetic acid solution). The Mₙ and M_{w} were determined by SEC to be 33,000 and 78,000, respectively.

### Methods

### Standard Glass Plate Preparation

When films are to be cast onto a work device such as a glass plate, it is important that the glass plate surface be clean. The following cleaning procedure was used for the examples, but any thorough cleaning procedure would be suitable. A Pyrex® glass plate is washed with PEX lab soap, rinsed with water, and wiped dry. The plate is then cleaned with methanol and, finally, coated and rubbed with 10 wt % aqueous NaOH solution and allowed to stand for ten minutes. The plate is ready for casting after a final rinse with water and drying with soft paper towels.

### Molecular Weight Determination

The molecular weights of the chitosan samples are determined by size exclusion chromatography using a triple-detector aqueous system, consisting of a Waters 2690 separations module, a Wyatt-DAWN DSP multi-angular (18) light scattering detector, a Waters 410 differential refractometer (Waters Corporation, Milford, Mass., USA), and a Viscotek T60-B viscometer (Viscotek, Houston, Tex., USA). Two TSK-GEL GMPW columns (TOSOH Bioscience LLC, TOSOH Corporation, Tokyo, Japan) are used. The mobile phase is an aqueous solution of 0.3M acetic acid with 0.3M sodium acetate at a flow rate of 0.5 mL/min. The samples have been first dissolved for 4 hours in a shaker.

### Moisture Vapor Transmission Rate (MVTR)

This was measured by a method derived from the Inverted Cup method of MVTR measurement [ASTM E 96 Procedure BW, Standard Test Methods for Water Vapor Transmission of Fabrics (ASTM 1999)]: A vessel with an opening on top is charged with water and then the opening is covered first with a moisture vapor permeable (liquid impermeable) layer of expanded-PTFE film (“ePTFE”), and then with the sample for which the MVTR is to be measured, and finally by woven fabric overlayer [NYCO 50:50 nylon/cotton blend, 6.7 oz/yd² (0.23 kg m²) or Nomex® fabric, 5.6 oz/yd² (0.19 kg/m²), both treated with durable water repellant finish]. The three layers are sealed in place thereby forming a laminate, inverted for 30 minutes to condition the layers, weighed to the nearest 0.001 g, and then contacted with a dry stream of nitrogen while inverted. After the specified time, the sample is re-weighed and the MVTR calculated (kg m²/24 h) by means of the following equation:

MVTR=1/[(1/MVTR_{obs}.)−(1/MVTR_{mb})]

where MVTR_{obs} is observed MVTR of the experiment and MVTR_{mb} is the MVTR of the ePTFE moisture barrier (measured separately). The reported values are the average of results from four replicate samples.

### Dimethylmethylphosphonate (“DMMP”) Permeation

DMMP is used as a relatively non-toxic simulant for chemical warfare G-class nerve agents. The DMMP permeation for the examples described below was carried out as follows: A vessel with an opening on top was charged with a measured amount of water containing 0.100% propylene glycol as an internal GC standard. If the sample was a film, the opening was covered with the sample film and a woven fabric overlayer [NYCO 50:50 nylon/cotton blend, 6.7 oz/yd² (0.23 kg m²) or Nomex®, 5.6 oz/yd² (0.19 kg/m²), both treated with durable water repellant finish] was placed on top of the film, and the layers were sealed in place thereby forming a laminate. If the sample was a laminate that already had a fabric surface, no additional fabric overlayer was used. In both types of samples, the fabric surface was treated with one 2 μL drop of DMMP (2.3 mg). The vessel was placed in a nitrogen-purged box for 17 h and then the DMMP concentration in the water was measured by GC analysis. Results are reported in pg of DMMP measured in the water after 17 h and are the average of five replicate samples. The DMMP was obtained from Aldrich Chemical Company (Milwaukee, Wis., USA) and was used as received.

### Linear Shrinkage Measurements

Linear shrinkage was determined using this method: Strips of the films to be tested, usually about 1 cm wide and 3 to 6 cm long are placed in a shallow dish with water and soaked for about 10 to 20 minutes. Water pickup is visually rapid and typically appears to be complete in less than one minute. When water pickup appears to be complete, the strips are gently floated onto a glass microscope slide with an excess of water. The wet films are slid off the microscope slide onto a paper sheet and the length of each wet film strip is measured (“wet length”). As the films dry, they are periodically gently moved to prevent sticking to the paper, since sticking would inhibit shrinkage. When completely dry under ambient conditions, the film lengths are again measured (“dry length”). The percent linear shrinkage for each film strip is calculated as:

100 (wet length−dry length)/wet length.

### Example 1

This Example illustrates the preparation and properties of an N-methylchitosan film.

A Pyrex® glass bottle (200 mL) was charged with:
9.8 g (60 mmol NH₂ groups) of powdered chitosan that had been dried at 100° C.
100 g isopropylalcohol
7.6 g (60 mmol) dimethyl sulfate

The mixture was heated to 80° C. then rotated on a roll mill until it cooled to room temperature. This heating and rotating was repeated three more times. The solid N-methylchitosan thereby produced was collected by filtration, washed with water, and dried. The solid was dissolved in 200 mL of water containing 2.76 g formic acid. The solution was pressure filtered through coarse filter paper, degassed, cast onto a glass plate with a 25 mil (0.64 mm) box doctor knife, and dried at 100° C. The film was freed from the formate anion by soaking in 10% sodium hydroxide/water for 4 min at room temperature. The film peeled easily from the glass plate. It had the following properties:

| | |
|---|---|
| Shrinkage | 33% |
| MTVR | 34 kg/m²/24 h. |
| DMMP transport rate | 0 μg in 17 h . . . |

### Example 2

This Example illustrates the preparation and properties of an N-methylchitosan film using a different methylating mixture.

The process of Example 1 was repeated except that the methylating mixture contained:
9.8 g (60 mmol NH₂ groups) of powdered chitosan that had been dried at 100° C.
2.4 g sodium hydroxide
50 mL isopropyl alcohol
7.6 g (60 mmol) dimethyl sulfate

The reaction mixture possessed a faint odor of methylamines. The solid N-methylchitosan was converted to film as described in Example 1 and had these properties:

| | |
|---|---|
| Shrinkage | 45% |
| MTVR | 33.4 kg/m²/24 h. |
| DMMP transport rate | 2 μg in 17 h . . . |

### Example 3

In this example, the chitosan was methylated to a higher degree by increasing the molar ratio of dimethyl sulfate to chitosan NH₂ groups from 1:1 (Example 1) to 3:1, and the film was subjected to various post-treatments.

The reaction was carried out in a bottle as described in Example 1.

The bottle was charged with:
9.8 g (60 mmol NH₂ groups) of powdered chitosan that had been dried at 100° C.
50 g water
7.2 g (180 mmol) sodium hydroxide
50 g isopropyl alcohol
22.8 g (180 mmol) dimethyl sulfate

The temperature of this mixture was increased slowly from 20° C. to 36° C. After 1.5 h, the N-methylchitosan was collected by filtration, washed with water, and dried. Five grams of this N-methylchitosan was dissolved at room temperature in 95 g water containing 1.4 g formic acid. After filtration and degassing, a film was prepared by casting onto a glass plate and drying at 100° C. It was divided into three portions and treated as follows:
Section 1 was treated with 10% aqueous NaOH, washed with water, and dried.
Section 2 was heated at 165° C. for 5 min in an aluminum foil envelope under a nitrogen atmosphere.
Section 3 was first subjected to the same heat treatment as Section 2, then treated with 10% aqueous NaOH, washed with water and dried, as for Section 1.
Section 4 was prepared by heating a sample of Section 1 at 170° C. for 5 min in an aluminum foil envelope under nitrogen.
The properties of the films are presented in Table 1.

TABLE 1

| Sample | | | |
|---|---|---|---|
| Section 1 | Section 2 | Section 3 | Section 4 |
| Film Treatment | | | |
| | | 165° C. | 10% aqueous |
| 10% | | for 5 min, | NaOH, |
| aqueous | 165° C. | then 10% | then 170° C. |
| for 5 min | NaOH | aqueous NaOH | for 5 min |

| | | | | |
|---|---|---|---|---|
| MVTR | 16.9 | 24.4 | — | 24.4 |
| (kg/m²/24 h) | | | | |
| DMMP | 0 | 0 | — | 0 |
| (μg in 17 h) | | | | |
| Shrinkage (%) | 40 | 35 | 29 | 8 |

### Example 4

This Example demonstrates that N-methylchitosan film shrinkage is lowered by incorporating a polyhydroxyalkyl compound.

To 18 g of 5.6% N-methylchitosan solution as the formate salt in water (prepared as in Example 1) was added 25 mg pentaerythritol. The mixture was rotated until the pentaerythritol had dissolved and then was cast onto a glass plate. The resulting film was placed on a 99° C. press platen (no pressure) for 4 to 5 min, until just dried-no longer. The dry state was determined visually. The film was removed from the glass, placed in an aluminum foil envelope under nitrogen and heated at 104° C. for 5 min. Its properties are presented in Table 2, in comparison with the N-methylchitosan film prepared in Example 1.

TABLE 2

Sample

| | | N-methylchitosan |
|---|---|---|
| | N-methylchitosan | with pentaerythritol |
| | (Example 1) | (Example 4) |
| MVTR (kg/m²/24 h) | 33.4 | 28.1 |
| DMMP (μg in 17 h) | 2 | 7 |
| Shrinkage (%) | 45 | 32 |

### Example 5

The procedure of Example 4 was repeated, except the pentaerythritol was replaced with 10 mg glucose. The resulting film was insoluble in aqueous formic acid and had these properties:

| | |
|---|---|
| Shrinkage | 28% |
| MTVR | 28.7 kg/m²/24 h. |
| DMMP transport rate | 3 μg in 17 h . . . |

### Example 6

This example demonstrates the preparation of a film from a solution of N-methylchitosan and chitosan. This composite film had remarkable resistance to tearing, a property that neither component possessed by itself.

A 1:1 by weight film of N-methylchitosan and chitosan was prepared by first mixing
10 g of a 5% solution of chitosan as the formate salt in water with
8.3 g of a 6% solution of N-methylchitosan as the formate salt in water.

After tumbling the mixture end over end for 1 h, the bubble free solution was cast on a glass plate with a 30 mil (0.76 mm) box doctor knife, and dried. The resulting film was treated with 10% aqueous sodium hydroxide for 2 min, washed free of base, and dried. Its properties are presented in Table 3, in comparison with the properties of chitosan and N-methylchitosan films. Tear resistance was determined qualitatively on 1 inch by 2 inch (2.5 cm by 5.0 cm) dry films by twisting. The chitosan and the N-methylchitosan tore easily whereas the composite did not tear.

| | Sample | | |
|---|---|---|---|
| | 1:1 Composite | | |
| | (Example 6) | N-Methylchitosan | Chitosan |
| MVTR (kg/m²/24 h) | 21.1 | 23-34 | 25-30 |
| DMMP (μg in 17 h) | 0 | 0 | 0 |
| Tear Resistance | Good | Poor | Poor |

Where an apparatus or method is stated or described herein as comprising, including, containing, having, being composed of or being constituted by certain components or steps, it is to be understood, unless the statement or description explicitly provides to the contrary, that one or more components or steps other than those explicitly stated or described may be present in the apparatus or method. Alternatively, an embodiment of an apparatus or method of this invention may be stated or described as consisting essentially of certain components or steps, indicating the absence of components or steps that would materially alter the principle of operation or the distinguishing characteristics of the apparatus or method. Further, if an apparatus or method is stated as consisting of certain components or steps, components or steps other than those as stated or described are not present therein.

Where the indefinite article “a” or “an” is used with respect to a statement or description of the presence of a component in an apparatus, or a step in a method, of this invention, it is to be understood, unless the statement or description explicitly provides to the contrary, that the use of such indefinite article does not limit the presence of the component in the apparatus, or of the step in the method, to one in number.

What is claimed is:

1. A method of inhibiting the permeation of a chemically or biologically harmful agent through a laminate or a structure or item of apparel fabricated therefrom, by including within the laminate a continuous N-alkylchitosan film.

2. A selectively permeable protective structure comprising a continuous N-alkylchitosan film and at least one layer of fabric.

3. The selectively permeable structure according to claim 2 wherein said structure is a laminate comprising a continuous N-alkylchitosan film and at least one layer of fabric.

4. The selectively permeable structure according to claim 3 wherein the N-alkylchitosan film further comprises one or more members selected from the group consisting of natural polymers, synthetic polymers, crosslinking agents, fillers, flame retardants, plasticizers, tougheners, and stabilizers, and wherein the film comprises at least 50% N-alkylchitosan by weight.

5. The selectively permeable structure according to claim 4 wherein the N-alkylchitosan film further comprises a natural polymer and said natural polymer is chitosan.

6. The selectively permeable structure according to claim 3 further comprising a substrate onto which the N-alkylchitosan film is cast from solution, wherein the substrate is essentially without protrusions above the plane of the substrate that are higher than the desired thickness of the coating of N-alkylchitosan that will be transformed into the film.

7. The selectively permeable structure according to claim 6 wherein the substrate is selected from the group consisting of films, sheets, and microporous membranes.

8. The selectively permeable structure according to claim 6 wherein the substrate comprises at least a film of one material selected from the group consisting of polar polymers wherein the polar polymer is an elastomer, glassy polymer, or semi-crystalline material.

9. The selectively permeable structure according to claim 8 wherein the polar polymer is selected from the group consisting of perfluorosulfonic acid tetrafluoroethylene copolymers, polyurethanes, polyether block polyamide copolymers, polyether block polyester copolymers, sulfonated styrene-polyolefin di- and tri-block copolymers, and polyvinyl alcohol homopolymers and copolymers.

10. The selectively permeable structure of claim 3 further comprising an outer shell, and optionally an inner liner, each independently comprising at least one member of the group consisting of woven fabric, nonwoven fabric, films, and microporous membranes.

11. The selectively permeable structure according to claim 10 wherein the woven or nonwoven fabric comprises one or more members selected from the group consisting of aramid, polybenzimidazole, nylon, and cotton.

12. The selectively permeable structure according to claim 3 wherein the Moisture Vapor Transport Rate is at least 2 kg m²/24 h and the transport rate of at least one chemical or biological agent harmful to human health is low enough to prevent the occurrence of injury, illness or death caused by said chemical or biological agent.

13. The selectively permeable structure according to claim 12 wherein the chemical or biological agent is selected from the group consisting of toxic industrial chemicals, nerve agents, vesicant agents,, tear gases, viruses, bacteria, and toxins.

14. The selectively permeable structure of claim 13 wherein the chemical agent is selected from the group consisting of phosgene, chlorine, acrylonitrile, parathion, O-isopropyl methylphosphonofluoridate, O-pinacolyl methylphosphonofluoridate, O-ethyl N,N-dimethylphosphoramidocyanidate, O-ethyl S-2-diisopropylaminoethyl methylphosphonothiolate, Lewisites, nitrogen mustards, sulfur mustards, bromobenzyl cyanide, phenylacyl chloride, o-chlorobenzylidene malononitrile, capsaicinoids, and dibenzoxazepine,

15. The selectively permeable structure according claim 3 further comprising at least one additional layer.

16. A finished article incorporating a laminate comprising a continuous N-alkylchitosan film and at least one layer of fabric.

17. The finished article according to claim 16 wherein said article is selected from the group consisting of items of apparel, shelters, and protective covers.

18. An item of apparel according to claim 17 wherein the item of apparel is selected from the group consisting of coveralls, protective suits, coast, jackets, limited-use protective garments, raingear, ski pants, gloves, socks, boots, shoe or boot covers, trousers, hoods, hats, masks, shirts and medical garments.

19. A medical garment according to claim 18 wherein the medical garment is selected from the group consisting of medical or surgical gowns, gloves, slippers, shoe or boot covers, and head coverings.

20 The method of claim 1 wherein said method provides protection of military personnel against dermal exposure to chemical and biological agents potentially encountered in a warfighter environment; protection of first responder personnel from chemical or biological agents in an emergency response situation; or protection of cleanup personnel from chemical or biological agents during a hazmat response situation.

21. A composite film comprising chitosan and N-methylchitosan.
